(19) United States
(12) Patent Application Publication
(10) Pub. No.: US 2004/0249648 A1
(43) Pub. Date: Dec. 9, 2004

(54) Device for renting or distributing and returning articles

(76) Inventors: Klaus-Dieter Rosler, Weyhe (DE); Reiner Gradwohl, Osthofen (DE)

Correspondence Address: Foley & Lardner, Suite 500, 3000 K Street NW, Washington, DC, 20007-5109, US

(21) Appl. No.: 10/477,100

(22) PCT Filed: May 10, 2002
(86) PCT No.: PCT/EP02/05184

(30) Foreign Application Priority Data
May 9, 2001 (DE) 101223676

(51) Int. Cl. G06F 17/60

(52) U.S. Cl. 705/1

(57) ABSTRACT

The invention relates to a device for renting or distributing and returning articles, in particular tools, machines, etc., from an article store to a customer or employee,

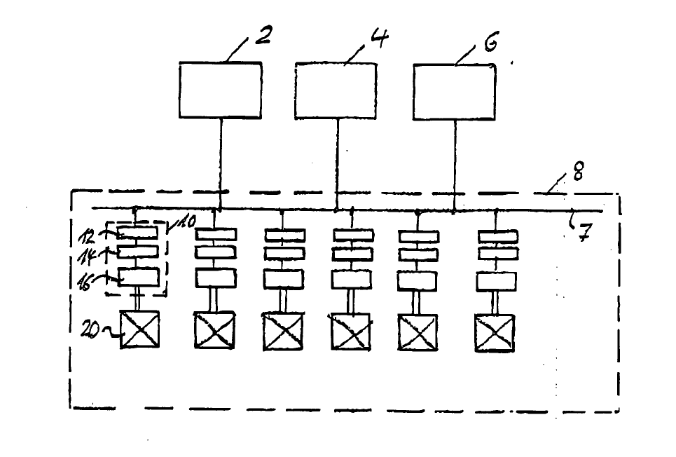

having a central control unit for processing and storing article-related and customer-related data,

having data entry means for entering the individual customer identification data, and

having storage means on the individual articles for storing article identification data which identify the article. The device is characterized by in each case an electronically actuated lock for each individual article for connecting or including the relevant article to or in the article store,

means for data communication between lock, the control unit and the data entry means,

the lock releasing the article upon receipt of a release command which is triggered by customer identification data with access authorization, and the control unit receiving a removal signal identifying a removal operation when the relevant article is removed, and having means which, when an article is again connected to or included in a free lock, report the relevant article identification data to the control unit.

The invention relates to a device for renting or distributing and returning articles, in particular tools, machines, etc., from an article store to a customer or employee, having a central control unit for processing and storing article-related and customer-related data, having data input means for the input of the individual customer identification data, and having storage means on the individual articles for the storage of article identification data which identifies the article.

During the distribution or the renting or the hiring of articles, in particular when hiring tools, devices or machines to third parties, for example to manual workers, operating personnel are used who have to carry out time-consuming operations until the customer receives the desired articles and, in particular, also until the renting operation has been documented and stored adequately. If the article is then returned, that is to say the rental is completed, then the personnel must ensure that the article returned is identical with the article hired out. In addition, the state of the article after return must be checked, finally the rental period must be registered and a settlement procedure must be carried out by using the article-related and the customer-related data. In the case of the known stock-keeping and of the known device for distributing or renting articles, these steps are time-consuming, laborious and expensive.

It is therefore an object of the invention to develop a device of the type cited at the beginning such that simple, cost-effective performance of a rental procedure for articles is reliably possible.

In the case of the device of the type cited at the beginning, this object is achieved according to the invention by in each case an electronically actuated lock for each individual article for connecting or including the relevant article to or in the article store, means for data communication between lock, the control unit and the data entry means, the lock releasing the article upon receipt of a release command which is triggered by customer identification data with access authorization, and the control unit receiving a removal signal identifying a removal operation when the relevant article is removed, and having means which, when an article is again connected to or included in a free lock, report the relevant article identification data to the control unit.

The advantages of the invention reside in particular in the fact that the individual articles which are kept ready for rental or for hire are in each case connected to an electronically actuated lock or are included in individual locking compartments and are only released for removal by the customer when the customer identification data which, for example, the customer carries with him in the form of a smart card, has previously been entered and, following a check on the access authorization, a release command is generated, for example by the control unit, and opens the lock assigned to the desired article. The customer identification data which has brought about a release command and therefore opening of the lock, and the article identification data of the article released as a result are transmitted to the central control unit and stored there before or during the release of the article.

During the return of the article, the article is again connected to a lock or enclosed in a corresponding locking compartment; means are provided which, during this procedure, read from the article the article identification data which identifies the relevant article and report it to the control unit, so that the control unit can as a result calculate the time period of the rental procedure and can also charge the customer who has removed the article by using the stored, appropriate customer data.

The advantages of the device according to the invention reside in particular in the fact the customer data of that customer who can remove an article by actuating the electronic lock and, in addition, the article identification data of the article removed are registered and that, when the article is returned, the article must be connected to one of the free locks or enclosed by one of the latter and, in the process, the relevant article identification data is registered again, so that customer and hire period and the article rented are identified and the rental can be charged in a simple manner. This device according to the invention permits the entire distribution and return procedure to be processed automatically, that is to say without personnel, which means that considerable potential rationalization can be implemented.

According to a preferred embodiment of the invention, the data entry means are arranged centrally. In addition, article selection means—for example from a database of catalogue information that can be called up—can preferably be called up with pictorial support, so that the customer can select the desired article on the article selection terminal. As a result of passing on the release command generated on the basis of authorized customer identification data to the lock, the customer can then remove the article—following appropriate activation of the lock; in addition, customer identification data and article identification data are reported to the control unit and registered there for further data processing.

Alternatively, it is possible to provide each lock with a data entry means, so that the entry of the individual customer identification data and his authorization check is performed at the location at which the lock, the data entry and the article are located, that is to say, in the case of this embodiment of the invention, the relevant customer can himself select the article in the article store, he can then open the lock by means of entering the customer identification data, which is located on a smart card, for example, and is checked for access authorization. Via the lock, the article identification data which, for example, is stored in an electronic memory on the article, can be reported to the control unit. For this purpose, the electronic lock also implements an electric connection to the electronic storage means of the article, so that the control unit can read out the corresponding article identification data—for example following activation of the lock by means of customer identification data entries—and store it in the control unit.

In the case of returning the article, it is sufficient to register only the article identification data of the returned article—for example as a result of being coupled to the electronic lock again. In addition, however, the individual customer identification data can also be entered and the data entry means of a free lock to which the article is to be connected, so that the control unit can also register information about the customer who is returning the article.

According to a particularly preferred embodiment of the invention, following a return of the article, which is carried out by connection to a previously free lock, the relevant lock is changed into a barred state and is unbarred again for renewed distribution only after a predefinable time or at predefinable event. During the barred state or during the time, the returned article can then be checked for the state of maintenance and serviceability, deficiencies established may be charged to the relevant customer who has last hired the article. Following the performance of an appropriate inspection or overhaul, the lock is then unbarred again, the article is available for a new rental procedure. This embodiment of the invention has the advantage that the inspection or checking of the articles is not carried out upon return but can be carried out at a time chosen freely by the operator of the device, which means that the costs for providing personnel can be reduced further.

Advantageous developments of the invention are characterized by the features of the subclaims. In the following text, an exemplary embodiment of the invention will be explained in more detail using the drawing.

The figure shows a schematic block diagram of the device according to the invention. The block diagram shows a central control unit 2, which is used for processing and storing article-related and customer-related data and also for testing the access authorization of customer identification data and/or for managing the stock of articles. Also provided are data entry means 4 which, for example, can be arranged in the entry region of the article store 8. Article selection terminals 6 may likewise be provided, for example in the entry region of the article store 8, on which the customer can select the desired articles from a database, preferably assisted by a monitor.

The control unit 2, the data entry means 4 and the article selection terminals 6 are coupled to a data bus 7, to which a plurality of electronically actuated locks 10 are connected. An article 20 is fixed mechanically to or included in a lock 10 and, when the lock is opened, can be removed from the lock 10 and therefore from the article store 8. The individual locks 10 contain means 12 which permit data communication between lock, the control unit 2 and, if appropriate, the central data entry means 4 and/or the article selection terminals 6. The locks 10 further contain means 14 of actuating the lock as a function of a release command which is derived from the customer identification data entered centrally and/or at the lock, which has previously advantageously been checked for its access authorization. The locks 10 moreover also have a mechanical closing device 16, which can be actuated by the means 14 and to which the articles 20 can be connected.

Arranged on the individual articles 20 are storage means 22 which store the article identification data of the relevant article. These storage means are either permanently incorporated in the articles and are coupled to the bus 7 via the lock by means of a plug-in connection, so that the article identification data can be read out from the memory 22 either by the lock or by the control unit and can be reported to the control unit.

Alternatively, the storage means which store the article identification data can be arranged so as to be removable, as a smart card, or fixed to the article 20. Before or during the opening or renewed closing of the electric lock 10, the article identification data can be read out from the storage unit or else in a wire-free manner by [sic], for example by means of a transponder system, and supplied to the control unit, so that, before the removal of the article 20, the data about the customer and the data about the article removed are reliably present in the control unit and can be stored or processed there.

According to an embodiment of the invention, it is also possible to place the individual articles 20 in separate, mutually isolated locking compartments and to control the possible access to the articles by the locks 10 keeping the relevant locking compartments open or closed. In this embodiment, equipment is provided which ensures that, before the removal of an article, the article identification data is also supplied to the control unit 2.

Instead of central data entry means 4 which, for example, are set up at the entry to the article store, data entry means can alternatively also be provided on every lock for the entry and identification of the individual customer identification data of the customer who wishes to hire the relevant article. The data entry means of the lock report the customer data to the control unit, in addition the article identification data is also reported to the control unit before or during the opening of the lock, so that, when the article is removed, the control unit has available both customer identification data and article identification data and the time of removal. If the article is brought back into the article store 8 following use, that is to say the rental or hire has been completed, the article must again be connected to a free lock or enclosed by this lock. In this case, the article identification data of the returned article have to be read out from the storage means again and reported to the control unit in order that the control unit can check that the article originally hired out has also been returned. In addition, the registration of the customer identification data upon return of an article is possible; this registration of the customer identification data is carried out, for example, by using data entry means which report the customer identification data to the control unit 2 for further processing.

When an article is connected to or enclosed in a previously free lock 10, this lock is changed into a barred state for some time and only then unbarred again for renewed distribution of the article. During the barred state, customers cannot remove the article from the article store. During the barred interval, for example, an inspection or overhaul of the articles returned is carried out, in order that these can again be available for a further rental cycle.

1. A device for renting or distributing and returning articles, in particular tools, machines, etc., from an article store to a customer or employee,
having a central control unit for processing and storing article-related and customer-related data,
having data entry means for entering the individual customer identification data, and
having storage means on the individual articles for storing article identification data which identifies the article,
characterized by in each case an electronically actuated lock (10) for each individual article for connecting or including the relevant article to or in the article store (8),
means for data communication (12) between lock (10), the control unit (2) and the data entry means (4),
the lock (10) releasing the article (20) upon receipt of a release command which is triggered by customer identification data with access authorization, and the control unit (2) receiving a removal signal identifying a removal operation when the relevant article is removed,
and having means which, when an article is again connected to or included in a free lock (10), report the relevant article identification data to the control unit (2).

2. The device as claimed in claim 1, characterized in that the data entry means (4) are arranged centrally, and in that article selection means (6) are provided, on which the customer selects the article desired by him, and in that the release command is transmitted to the lock (10) of the selected article (20).

3. The device as claimed in claim 1, characterized in that data entry means (4) for the entry and identification of the individual customer identification data are provided on each lock (10), and in that the lock and/or the data entry means report the customer identification data which trigger the release command for the lock and the article identification data which are associated with the article removed to the control unit when the relevant article is removed.

4. The device as claimed in claim 1, characterized in that, when an article is returned, the individual customer identification data can be entered at the data entry means (4) and supplied to the control unit (2).

5. The device as claimed in claim 1, characterized in that, following the connection or inclusion of an article (20), the relevant lock (10) is changed into a barred state and is unbarred again for the renewed distribution of the article only after a predefinable time or a predefinable event.

6. The device as claimed in claim 1, characterized in that the locks (10) can be driven with information and/or control commands by the central unit (2) individually or grouped in accordance with predefined criteria.

7. The device as claimed in claim 1, characterized in that the storage means (22) which store the article identification data are permanently arranged in the articles (20) and, by means of a plug-in connection, can be coupled electrically to the control unit (2) and read out via the lock (10).

8. The device as claimed in claim 1, characterized in that the storage means (22) which store the article identification data are arranged to be removable as a smart card or fixed to the article (20), in that the stored content of the smart card can be read out by means of a data reading device before or during the opening of the electronic lock (10) and can be supplied to the control unit (2).

9. The device as claimed in claim 1, characterized in that each lock (10) stores its own identification data and, if appropriate, localization data, which specifies the local position of the lock in the article store (8), and in that the lock identification data and/or the localization data of the lock are transmitted to the control unit (2) when a lock (10) is actuated or selected.

10. The device as claimed in claim 1, characterized in that the storage means (22) on the articles include a bar code.

11. A method for distributing and returning or renting articles from an article store, comprising data entry means, a central control unit for processing and storing article-related and customer-related data, which has the following steps:
a) entry of individual customer identification data at the entry to the article store and/or at a lock with which the article is secured
b) selection of the desired articles by the customer
c) release of the lock with which the article is secured
d) removal of the article, customer identification data and article identification data being reported to the control unit.

12. The method as claimed in claim 11, characterized in that, when the article is returned, the latter is again enclosed by the lock, the article identification data being reported to the control unit.

13. The method as claimed in claim 12, characterized in that, when the article is returned, the customer identification data is also reported to the control unit.

14. The method as claimed in claim 12, characterized in that the returned article is checked for state of maintenance and serviceability.

15. The method as claimed in claim 14, characterized in that, following the check for state of maintenance and serviceability, the article is released again for rental or for distribution.

16. The method as claimed in claim 13, characterized in that the returned article is checked for state of maintenance and serviceability.

17. The method as claimed in claim 16, characterized in that, following the check for state of maintenance and serviceability, the article is released again for rental or for distribution.
